(19) United States
(12) Patent Application Publication
(10) Pub. No.: US 2025/0374127 A1
(43) Pub. Date: Dec. 4, 2025

(54) SMOOTH AND SEAMLESS VERTICAL HANDOVER PROCEDURE

(71) Applicant: Technology Innovation Institute - Sole Proprietorship LLC, Masdar City (AE)

(72) Inventor: Fouzi BOUKHALFA, Yas Island (AE)

(73) Assignee: Technology Innovation Institute - Sole Proprietorship LLC, Masdar City (AE)

(21) Appl. No.: 19/207,733

(22) Filed: May 14, 2025

Related U.S. Application Data
(60) Provisional application No. 63/654,188, filed on May 31, 2024.

(51) Int. Cl. H04W 36/00; H04L 41/16; H04W 28/086

(52) U.S. Cl. CPC H04W 36/0022; H04L 41/16; H04W 28/0861

(57) ABSTRACT

A vehicle communication system for performing vertical handover (VHO), comprising a communication transceiver comprising a plurality of access points configured to receive and transmit wireless signals via different networks, and a processor operatively connected to the communication transceiver, the processor configured to implement a first VHO signaling process to control the communication transceiver to gather network information from the different networks, execute a VHO decision-making algorithm to determine, based on the gathered network information, one or more of the different networks through which to transmit messages via one or more of the plurality of access points, the VHO decision-making algorithm comprising executing a reinforcement learning algorithm that adjusts VHO policy based on message reception success rate and message transmission cost, and implement a second VHO signaling process to control the communication transceiver to execute the VHO to the determined one or more of the different networks.

### CROSS-REFERENCE TO RELARED APPLICATIONS

This application claims priority to U.S. Provisional Application No. 63/654,188, filed May 31, 2024, which is incorporated by reference in its entirety.

### FIELD

A method and system for smooth and seamless vertical handover procedure.

### BACKGROUND

The field of vehicular communication has seen rapid advancements in recent years, with the development of various communication networks such as Visible Light Communication (VLC) networks, and wireless radio networks such as 802.11 and 5G. These networks facilitate Vehicle-to-everything (V2X) communications, enabling vehicles to communicate with each other (V2V) and with infrastructure (V2I). The density of vehicles in these networks can approach the full capacity of the channel, leading to some vehicles being unable to communicate with the rest of the devices in the network. To address this, vertical handover (VHO) between communication networks is sometimes performed, allowing vehicles to switch from one network to another.

Despite the advancements in vehicular communication networks, the state-of-the-art VHO procedures present several challenges. Specifically, the decision-making process for VHO in these systems is often based on predefined parameters and does not effectively adapt to real-time changes in network conditions, road conditions, traffic conditions, and weather conditions. This lack of adaptability can lead to inefficient handovers, resulting in communication disruptions and reduced network performance. Additionally, the state-of-the-art VHO procedures do not effectively manage load balancing between different networks, which can lead to network congestion and reduced communication efficiency when the network density is high.

### SUMMARY

In one aspect, the present disclosure relates to a vehicle communication system for performing vertical handover (VHO), comprising a communication transceiver comprising a plurality of access points configured to receive and transmit wireless signals via different networks, and a processor operatively connected to the communication transceiver, the processor configured to implement a first VHO signaling process to control the communication transceiver to gather network information from the different networks, execute a VHO decision-making algorithm to determine, based on the gathered network information, one or more of the different networks through which to transmit messages via one or more of the plurality of access points, the VHO decision-making algorithm comprising executing a reinforcement learning algorithm that adjusts VHO policy based on message reception success rate and message transmission cost, and implement a second VHO signaling process to control the communication transceiver to execute the VHO to the determined one or more of the different networks.

In embodiments of this aspect, the disclosed system according to any one of the above example embodiments, wherein the processor is configured to trigger the execution of the VHO in response to detected network events or detected vehicle events.

In embodiments of this aspect, the disclosed system according to any one of the above example embodiments, wherein the plurality of access points comprises dedicated short-range communication (DSRC), vehicle-to-everything (V2X) communication and visible light communication (VLC).

In embodiments of this aspect, the disclosed system according to any one of the above example embodiments, wherein the processor is further configured to execute the VHO decision-making algorithm to determine execution of one of a single communication mode where the messages are transmitted over a single one of the different networks, a redundant mode where duplicate messages are transmitted over one or more of the different networks, or a load balancing mode where the messages are simultaneously transmitted over two or more of the different networks.

In embodiments of this aspect, the disclosed system according to any one of the above example embodiments, wherein the processor is further configured to perform load balancing when transmitting the messages over two or more of the different networks, the load balancing considering one or more of a load of one or more servers handling the messages, a payload of the messages and priority of the messages when determining routing of the messages through the different networks.

In embodiments of this aspect, the disclosed system according to any one of the above example embodiments, further comprising a sensor configured to collect data with respect to one or more of vehicle state, vehicle location, roadway conditions, traffic conditions and weather conditions, and the processor is further configured to fuse the data collected by the sensor with the gathered network information when executing the VHO decision-making algorithm.

In embodiments of this aspect, the disclosed system according to any one of the above example embodiments, wherein the processor is configured to prioritize active applications related to navigation and safety over non-safety-critical applications during the VHO.

In embodiments of this aspect, the disclosed system according to any one of the above example embodiments, wherein the processor is configured to postpone the VHO in response to detection of a safety-critical event until the event is no longer present.

In embodiments of this aspect, the disclosed system according to any one of the above example embodiments, wherein the processor is further configured to adjust the VHO decision-making algorithm based on a predictive model that anticipates future network conditions using historical network and sensor data and current trends.

In embodiments of this aspect, the disclosed system according to any one of the above example embodiments, wherein the processor is further configured to fuse camera images and point cloud images of the roadway into the VHO decision-making algorithm to enhance accuracy of network selection.

In one aspect, the present disclosure relates to a method for performing vertical handover (VHO) in a vehicle communication system, comprising implementing a first VHO signaling process to control a communication transceiver to gather network information from different networks, executing a VHO decision-making algorithm with a processor to determine, based on the gathered network information, one or more of the different networks through which to transmit messages via one or more of a plurality of access points, wherein the VHO decision-making algorithm comprises executing a reinforcement learning algorithm that adjusts VHO policy based on message reception success rate and message transmission cost, and implementing a second VHO signaling process to control the communication transceiver to execute the VHO to the determined one or more of the different networks.

In embodiments of this aspect, the disclosed method according to any one of the above example embodiments, further comprising triggering the execution of the VHO in response to detected network events or detected vehicle events.

In embodiments of this aspect, the disclosed method according to any one of the above example embodiments, wherein the plurality of access points comprise dedicated short range communication (DSRC), vehicle-to-everything (V2X) communication, and visible light communication (VLC).

In embodiments of this aspect, the disclosed method according to any one of the above example embodiments, further comprising executing the VHO decision-making algorithm by determining one of: a single communication mode where messages are transmitted over a single one of the different networks, a redundant mode where duplicate messages are transmitted over one or more of the different networks, or a load balancing mode where messages are simultaneously transmitted over two or more of the different networks.

In embodiments of this aspect, the disclosed method according to any one of the above example embodiments, further comprising performing load balancing when transmitting the messages over two or more of the different networks, considering one or more of a load of one or more servers handling the messages, a payload of the messages, and priority of the messages when determining routing of the messages through the different networks.

In embodiments of this aspect, the disclosed method according to any one of the above example embodiments, further comprising collecting data with respect to one or more of vehicle state, vehicle location, roadway conditions, traffic conditions, and weather conditions using a sensor, and fusing the data collected by the sensor with the gathered network information when executing the VHO decision-making algorithm.

In embodiments of this aspect, the disclosed method according to any one of the above example embodiments, further comprising prioritizing active applications related to navigation and safety over non-safety-critical applications during the VHO.

In embodiments of this aspect, the disclosed method according to any one of the above example embodiments, further comprising postponing the VHO in response to detection of a safety-critical event until the event is no longer present.

In embodiments of this aspect, the disclosed method according to any one of the above example embodiments, further comprising adjusting the VHO decision-making algorithm based on a predictive model that anticipates future network conditions using historical network and sensor data and current trends.

In embodiments of this aspect, the disclosed method according to any one of the above example embodiments, further comprising fusing camera images and point cloud images of the roadway into the VHO decision-making algorithm to enhance accuracy of network selection.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1A illustrates an exemplary vehicle communication system, according to aspects of the present disclosure.

FIG. 1B is a block diagram of the communication system within a vehicle, according to aspects of the present disclosure.

FIG. 2A is a block diagram of the software stack of an exemplary vehicle communication system, according to aspects of the present disclosure.

FIG. 2B is a flowchart outlining a process for vertical handover in the vehicle communication software stack, according to aspects of the present disclosure.

FIG. 3A is a flowchart outlining a process for vertical handover in a vehicle communication software stack, according to aspects of the present disclosure.

FIG. 3B is a flowchart illustrating the process of vertical handover decision making and execution in the vehicle communication software stack, according to aspects of the present disclosure.

FIG. 4A is a block diagram of data fusion for use in vertical handover decision making, according to aspects of the present disclosure.

FIG. 4B is a flowchart outlining a process for managing vertical handover policy, according to aspects of the present disclosure.

FIG. 4C depicts a table that outlines the relationship between binary action codes and the corresponding access point selections for a vehicle communication mode, according to aspects of the present disclosure.

FIG. 5 is a flowchart outlining a process for managing communication loads, according to aspects of the present disclosure.

FIG. 6A shows an example of cumulative rewards for learning curves on the V2X simulated environment with 95% confidence intervals for five runs (seed), according to aspects of the present disclosure.

FIG. 6B shows an example of the SAC strategy action versus time plot, according to aspects of the present disclosure.

FIG. 6C shows an example of the TRPO strategy action versus time plot, according to aspects of the present disclosure.

FIG. 6D shows an example of the Rainbow DQN strategy action versus time plot, according to aspects of the present disclosure.

FIG. 6E shows an example of the PPO strategy action versus time plot, according to aspects of the present disclosure.

FIG. 6F shows an example of the PPO learned strategy distance versus angle plot, according to aspects of the present disclosure.

FIG. 6G shows an example of the TRPO learned strategy distance versus angle plot, according to aspects of the present disclosure.

FIG. 6H shows an example of the SAC learned strategy distance versus angle plot, according to aspects of the present disclosure.

FIG. 6I shows an example of the Rainbow DQN strategy distance versus angle plot, according to aspects of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

Current vertical handover (VHO) procedures in vehicular communication networks often rely on predefined parameters and do not effectively adapt to real-time changes in network conditions, road conditions, traffic conditions, and weather conditions. This lack of adaptability can lead to inefficient handovers, resulting in communication disruptions and reduced network performance. Additionally, existing VHO procedures do not effectively manage load balancing between different networks, which can lead to network congestion and reduced communication efficiency when the network density is high. The disclosed system and method address these issues by using a reinforcement learning algorithm for decision-making, which adapts to real-time changes and efficiently manages load balancing, thereby enhancing the overall performance of the vehicle communication system.

Specifically, the present disclosure pertains to a novel method and system for VHO in a vehicle communication system, leveraging Software-Defined Networking (SDN) for the separation of control and data planes. The system comprises a communication transceiver with multiple access points that can transmit and receive wireless signals via different networks. The system also includes a processor that controls the communication transceiver to gather network information, execute a VHO decision-making algorithm, and implement a VHO signaling process. The decision-making algorithm can use a reinforcement learning algorithm that adjusts the VHO policy based on the success rate of message reception and the cost of message transmission. This innovative approach ensures efficient and seamless handovers, improving the overall performance of the vehicle communication system. Furthermore, the system can employ a utility function for the selection of the Access Point (AP) during load balancing. This function can evaluate the performance of each AP based on various parameters such as signal strength, bandwidth, and latency, and can select the AP that maximizes the utility function, thereby optimizing the load balancing process.

The disclosed system and method can be applied in various real-world scenarios involving vehicular communication. For instance, in a scenario where a high density of vehicles is communicating over a network, the system can efficiently manage the network load by performing a VHO to another less congested network, thereby ensuring uninterrupted communication. In another scenario, the system can adapt to changing road and traffic conditions by adjusting the VHO policy in real-time, ensuring efficient communication even in dynamic environments. Furthermore, in a scenario involving safety-critical applications such as autonomous driving, the system can prioritize these applications during the VHO, thereby enhancing road safety. Thus, the disclosed system and method can improve the reliability and efficiency of vehicular communication in various real-world scenarios.

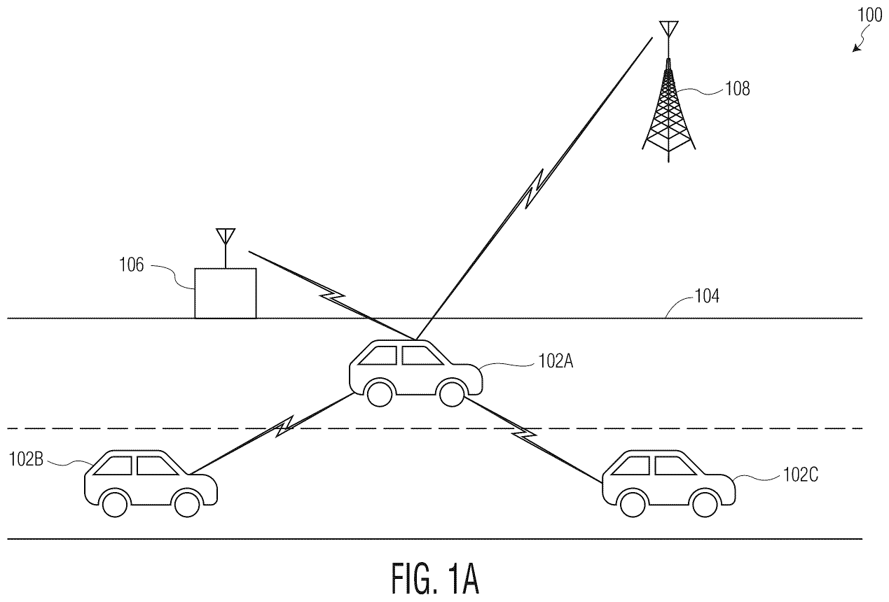

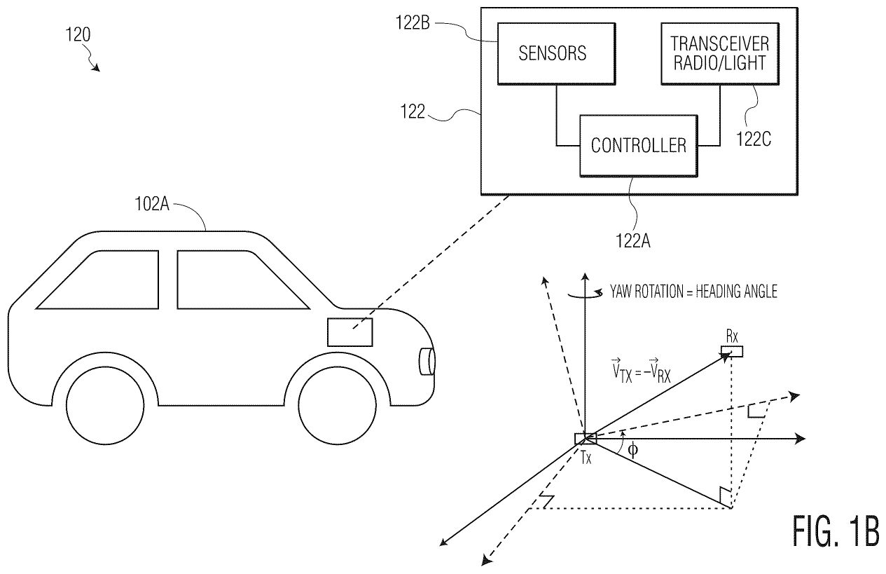

Turning to FIG. 1A, a schematic representation of a vehicle communication system 100 is depicted. System 100 may include a plurality of vehicles 102A, 102B, and 102C, a roadside unit 106, and a communication tower 108. The vehicles 102A, 102B, and 102C traveling on roadway 104 can communicate with each other, with the roadside unit 106 and the communication tower 108. This communication may be facilitated through various networks, such as cellular networks, short range communication networks, or other wireless networks. In some cases, the communication system 100 may be a vehicular ad hoc network, where each vehicle can directly communicate with any other vehicle within its communication range. Vehicles may also communicate with vehicles and devices outside of their range by using longer range communication technology or by message hopping between intermediate vehicles and roadside devices.

In some aspects, the vehicles 102A, 102B, and 102C may be equipped with a plurality of access points that facilitate communication over different networks. These access points may include but are not limited to cellular communications, dedicated short-range communication (DSRC), vehicle-to-everything (V2X) communication, and visible light communication (VLC) technologies. The DSRC technology may provide communication over short distances, making it suitable for applications such as vehicle-to-vehicle (V2V) and vehicle-to-infrastructure (V2I) communication. The V2X communication technology may provide a broader range of communication capabilities, including communication with other vehicles, infrastructure, pedestrians, and network services. The VLC technology may provide communication using visible light, which may be particularly useful in scenarios where radio frequency communication is not feasible or desirable. Visible light may be emitted by communication dedicated light sources or by standard vehicle light sources (e.g., headlights, taillights, etc.).

In other aspects, the vehicles 102A, 102B, and 102C may be equipped with different combinations of these access points. For example, a vehicle may be equipped with two or more of DSRC, V2X and VLC technology to name a few. The specific combination of access points in a vehicle may depend on various factors, such as the vehicle's communication requirements, the available network infrastructure, and the specific use case scenarios for the vehicle.

In the context of vehicular communication systems, vehicles 102A, 102B, and 102C communicate with each other and with infrastructure devices for a variety of reasons. For instance, V2V communication allows vehicles to share information about their speed, direction, and location to enhance road safety by preventing collisions and managing traffic flow. V2I communication, on the other hand, enables vehicles to interact with traffic signals, road signs, and other infrastructure elements to optimize route planning, reduce congestion, and improve overall traffic management. For example, a vehicle might communicate with a traffic signal to optimize its speed and reduce unnecessary stops, or with a roadside unit to receive updates about road conditions or traffic incidents. Furthermore, in the realm of autonomous driving, these communications become even more integral. Autonomous vehicles may rely heavily on V2V and V2I communications to navigate their environment, make informed decisions, and ensure the safety of their passengers and other road users.

Turning to FIG. 1B, a block diagram 120 of a communication system within a vehicle 102A is depicted. The communication system block diagram 120 illustrates the communication system components 122, which include a system controller 122A, system sensors 122B, and a radio and light transceiver 122C. The system controller 122A may be responsible for managing the operations of the communication system. This may include controlling the communication transceiver to gather network information from different networks, executing a VHO decision-making algorithm to determine one or more of the different networks through which to transmit messages, and controlling the communication transceiver to execute the VHO to the determined one or more of the different networks.

The system sensors 122B may collect various data relevant to the vehicle's operation and environment. This data may include, for example, vehicle speed, location, and direction, as well as network data such as signal strength, network congestion, and network latency. The collected data may be used by the system controller 122A in executing the VHO decision-making algorithm.

The radio and light transceiver 122C may facilitate wireless communication through different modalities, such as radio frequency and visible light signals. In some cases, the radio and light transceiver 122C may include a plurality of access points configured to receive and transmit wireless signals via different networks. As mentioned above, these access points may include one or more of DSRC, V2X communication, and VLC technologies.

As mentioned above, in a vehicular network, it is possible to approach the full capacity of the channel when the density of vehicles increases beyond a threshold. When this occurs, some vehicles may be unable to communicate with the rest of the network. Furthermore, in the countryside, some area may be not covered by the C-V2X. In these situations, combining radio frequency (RF) and V-VLC may be a suitable solution. When a degradation of the QoS for radio technology or another communication technology is detected, a VHO procedure may be initiated. A Deep Reinforcement Learning (DRL) agent allows the maintenance of high reliability that satisfies advanced autonomous vehicle applications in such situations. Different communication technologies differ in terms of their cost and success probability, which depend on the dynamic conditions of the vehicle environment. The agent also has the option to use redundant communication technologies to increase the success probability. This results in a complex decision that requires careful consideration of communication success and cost.

In one example, a reinforcement learning approach to the vehicle communication problem through a Markov decision process (MDP) model may be characterized by the example below:
State space [symbol] ⊆ [symbol] : where the state s∈ [symbol] is described as:

$$s = [ X = clip ( \frac{{x}_{{\vec{V}}_{T x}}}{R} , - 1 , 1 ) , Y = clip ( \frac{{y}_{{\vec{V}}_{T x}}}{R} , - 1 , 1 ) , cos ( ϕ ) = \frac{{x}_{{\vec{V}}_{R x}}}{‖ {\vec{V}}_{R x} ‖} , sin ( ϕ ) = \frac{{y}_{{\vec{V}}_{R x}}}{‖ {\vec{V}}_{R x} ‖} ] ,$$

where R is the maximum transmission range of DSRC (For example, R=10³ m, and Rₓ, Tₓ, \vec{V}_{Rx}, \vec{V}_{Tx} refer respectively to the receiver, the transmitter and their positional vectors as shown in FIG. 1B.
Action space [symbol] ={a₁, a₂, . . . , a₈} where the 8 possible actions correspond to: No transmission (a₁), DSRC (a₂), VLC Headlight (a₃), DSRC & Headlight (a₄), VLC Tail-light (a₅), DSRC & Taillight (a₆), Taillight & Headlight (a₇), all available technologies (a₈).
Probability transition P(s′|s, a) between states is generated by the environment. In this case, the chosen communication channel does not affect the trajectories of the cars, thus the transition kernel simplifies to P(s′|s).
Average reward function r(s, a)=p(s, a)−C(a) balances the communication success probability p(s, a) and the communication cost C(a).

If the agent performs an action a∈ [symbol] while the environment is in state s∈ [symbol] , then the next state s′˜P(·|s, a) is sampled from the distribution P(·|s, a) and the expected immediate reward is r(s, a).

The state representation s=(X, Y, cosϕ, sinϕ) for the V2X communication problem captures the agent's position and angle but lacks detailed information on other vehicles, environment factors, historical context, and specific communication channel properties. This makes it potentially inadequate for effective V2X communication. However, the simplicity of this model offers flexibility and may make it more generalizable across various scenarios.

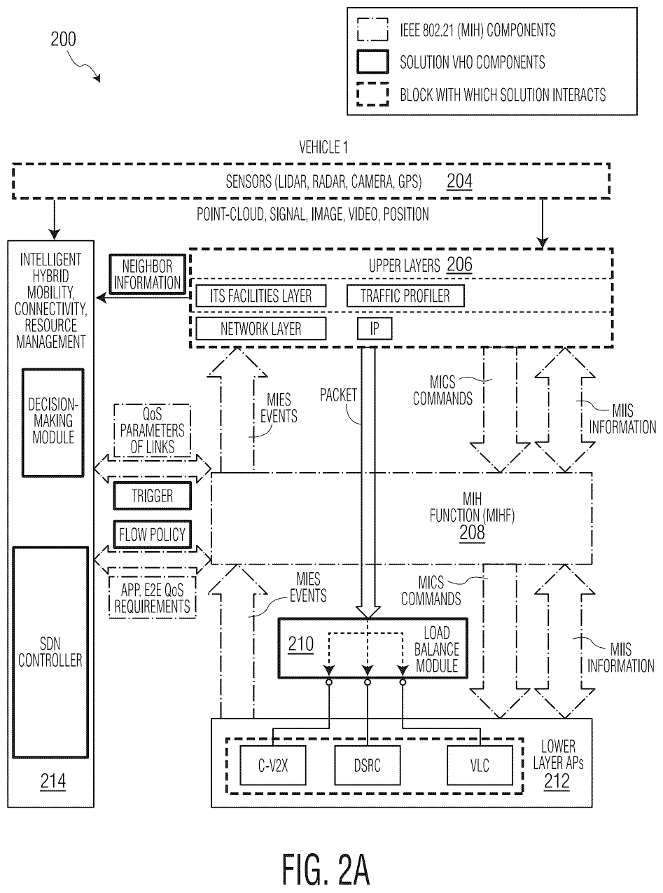

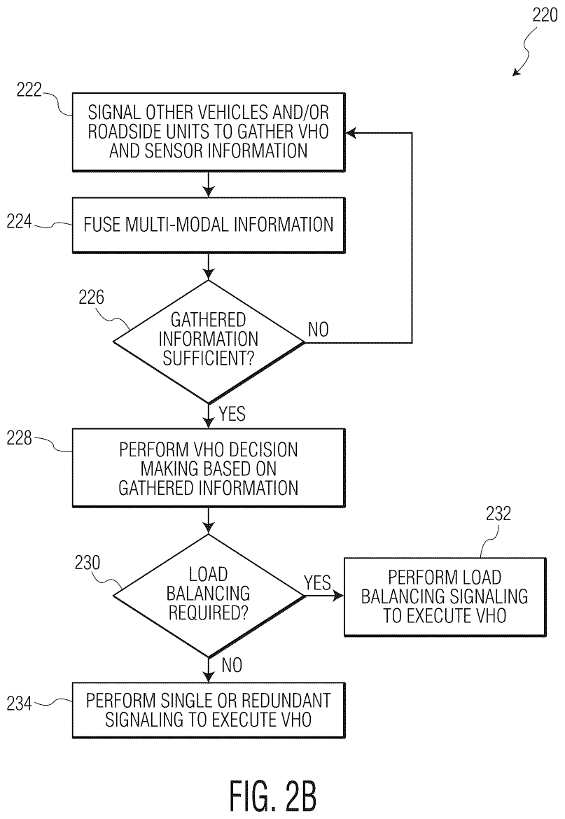

Turning to FIG. 2A, a block diagram of a software communication stack 200 for the vehicle communication system is depicted. The software communication stack 200 includes vehicle sensors block 204, an upper layers section 206, a Media Independent Handover (MIH) function module 208, a load balance module 210, lower layer access points 212, and an intelligent management module 214.

The vehicle sensors block 204 can collect various types of data from the sensors such as point-cloud, signal, image, video, and position data. This data can then be processed by the upper layers section 206, which includes the Intelligent Transportation Systems (ITS) facilities layer and the traffic profiler within the network layer. In some cases, the vehicle sensors block 204 may collect data related to the vehicle's operation and environment, such as vehicle speed, location, and direction, as well as network data such as signal strength, network congestion, and network latency.

MIH function module 208, a core component of the vehicle communication system, interacts with the upper layers section 206 through various services. These services include the Media Independent Event Service (MIES) events, Media Independent Command Service (MICS) commands, and Media Independent Information Service (MIIS) information. The MIH function module 208 is responsible for managing the handover policy and initiating the VHO process.

In the context of the VHO process, the MIH function module 208 implements a first VHO signaling process. This process controls a communication transceiver to gather network information from different networks. Subsequently, the MIH function module 208 executes a VHO decision-making algorithm. This algorithm, based on the gathered network information, can determine one or more of the different networks through which to transmit messages. The VHO decision-making algorithm can include the execution of a reinforcement learning algorithm. This algorithm can adjust the VHO policy based on the success rate of message reception and the cost of message transmission.

In some embodiments, the load balance module 210 operates in conjunction with the MIH function module 208 to manage the distribution of communication loads. In scenarios where messages are transmitted over two or more of the different networks, the load balance module 210 performs load balancing. This load balancing process can take into account factors such as the load of one or more servers handling the messages, the payload of the messages, and the priority of the messages. These factors can be considered when determining the routing of the messages through the different networks.

In some embodiments, the lower layer access points 212, which include various communication technologies, facilitate the actual transmission and reception of signals. In one example, these access points, configured to receive and transmit wireless signals via different networks, may include a combination of DSRC, cellular-V2X (C-V2X) communication, and VLC technologies. It is noted that the communication transceiver may be equipped with a versatile array of access points, potentially including N different access points, each utilizing distinct communication technologies. These access points may encompass a variety of technologies that each offer specific advantages and operate under different conditions, making them suitable for various vehicular communication scenarios. The access points can be utilized individually or in combination, depending on the requirements of the communication task at hand. The flexibility to combine these technologies allows the system to adapt to the dynamic nature of vehicular networks, ensuring robust and efficient communication across diverse situations.

In some embodiments, the intelligent management module 214, which includes the Software-Defined Networking (SDN) controller and the VHO decision-making module, can interface with the sensor block 204 and the MIH function module 208 to provide additional control and data exchange capabilities. The intelligent management module 214, in response to detected network events or detected vehicle events, can trigger the execution of the VHO. Furthermore, the intelligent management module 214 can adjust the VHO decision-making algorithm based on a predictive model. This model can anticipate future network conditions using historical network and sensor data and current trends.

In FIG. 2A, SDN can be utilized in the vehicle communication system to facilitate efficient and seamless VHO. Specifically, by separating the control and data planes, SDN allows for dynamic network configuration and optimization, enhancing the overall performance of the vehicle communication system. This can result in improved network load management, reduced communication disruptions, and increased adaptability to real-time changes in network, road, traffic, and weather conditions.

A control plane is generally responsible for making decisions about where traffic is sent. In FIG. 2A, the control plane components may include:
1. Upper layers section 206 which is responsible for processing the data collected by the vehicle sensors block 204. In some embodiments, it may include the ITS facilities layer and the traffic profiler within the network layer, which make decisions about network traffic based on the processed data.
2. MIH function module 208 which interacts with the upper layers section 206 and is responsible for the implementing the handover policy and triggering the VHO process. In some embodiments, it makes decisions about when and how to perform VHO based on the gathered network information and the output of the VHO decision-making algorithm from module 214.
3. Load balance module 210 which works in conjunction with the MIH function module 208 to manage the distribution of communication loads. In some embodiments, it makes decisions about how to balance the load when transmitting messages over two or more networks.
4. Intelligent management module 214 which interfaces with the sensor block 204 and the MIH function module 208 to provide control and data exchange capabilities. In some embodiments, it can trigger the execution of the VHO and adjust the VHO decision-making algorithm based on detected network events or vehicle events, and predictive models.

In contrast, the data plane is generally responsible for processing packets and forwarding them to their destination. In FIG. 2A, the data plane components may include:
1. Vehicle sensors block 204 which collects various types of data such as point-cloud, signal, image, video, and position. In some embodiments, the collected data may be forwarded to the upper layers section 206 for processing.
2. Lower layer access points 212 which include various communication technologies, and facilitate the actual transmission and reception of signals. In some embodiments, they process and forward the packets to their destination based on the decisions made by the control plane components.

Referring to FIG. 2B, a flowchart of a VHO process 220 is depicted. In some embodiments, the process generally includes step 222 for signaling other vehicles, step 224 for information fusion, step 226 for determining if information is sufficient, step 228 for performing VHO decision making, step 230 for determining if load balancing is required, step 232 for performing load balancing and step 234 for executing VHO.

The VHO process begins with a signaling other vehicles step 222, where the system signals other vehicles and/or roadside units to gather VHO and sensor information. Specifically, the signaling other vehicles step 222 may involve the system controller 122A implementing a first VHO signaling process to control a communication transceiver to gather network information from different networks. The gathered information may include data related to the vehicle's operation and environment, such as vehicle speed, location, and direction, as well as network data such as signal strength, network congestion, and network latency.

Following the signaling other vehicles step 222, the process proceeds to an information fusion step 224, where multi-modal information is fused. This fusion of information may involve the system controller 122A combining the data collected by the vehicle sensors block 204 with the gathered network information. The fused information may provide a comprehensive view of the vehicle's operation and environment, as well as the state of the different networks.

The process then checks for information sufficiency 226. If the gathered and fused information is sufficient for supporting VHO, the process proceeds to the VHO decision-making step 228. The VHO decision-making step 228 may involve the system controller 122A executing a VHO decision-making algorithm to determine, based on the gathered and fused information, one or more of the different networks through which to transmit messages. In some cases, the VHO decision-making algorithm may include executing a reinforcement learning algorithm that adjusts VHO policy based on message reception success rate and message transmission cost. In other cases, the VHO decision-making algorithm may use deep reinforcement learning (DRL), such as Proximal Policy Optimization (PPO), to adapt to the dynamic and stochastic nature of the vehicular network. The VHO decision-making algorithm may also formulate VHO as a Markov Decision Process (MDP).

Depending on whether load balancing is determined to be beneficial, as determined by the load balancing determination step 230, the process either performs a load balancing execution step 232 or proceeds directly to the VHO signaling execution step 234. The load balancing execution step 232 may involve the system controller 122A and the load balance module 210 managing the distribution of communication loads. This may involve performing load balancing when transmitting the messages over two or more of the different networks, considering one or more of a load of one or more servers handling the messages, a payload of the messages, and a priority of the messages when determining routing of the messages through the different networks.

The VHO signaling execution step 234 can involve the system controller 122A implementing a second VHO signaling process to control the communication transceiver to execute the VHO to the determined one or more of the different networks. The result of the VHO may involve the system controller 122A controlling the communication transceiver to transmit messages over one of the different networks, duplicate messages over one or more of the different networks, or simultaneously transmit messages over two or more of the different networks. The specific mode of communication may be determined by the VHO decision-making algorithm based on the gathered and fused information, the output of the reinforcement learning algorithm, and the results of the load balancing check step 230.

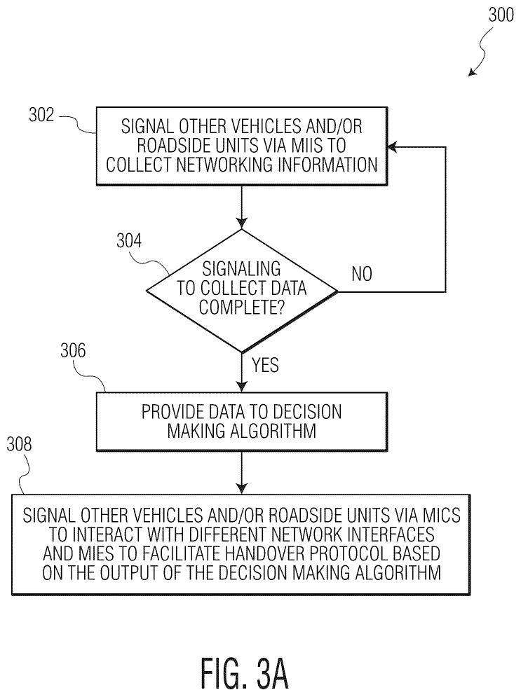

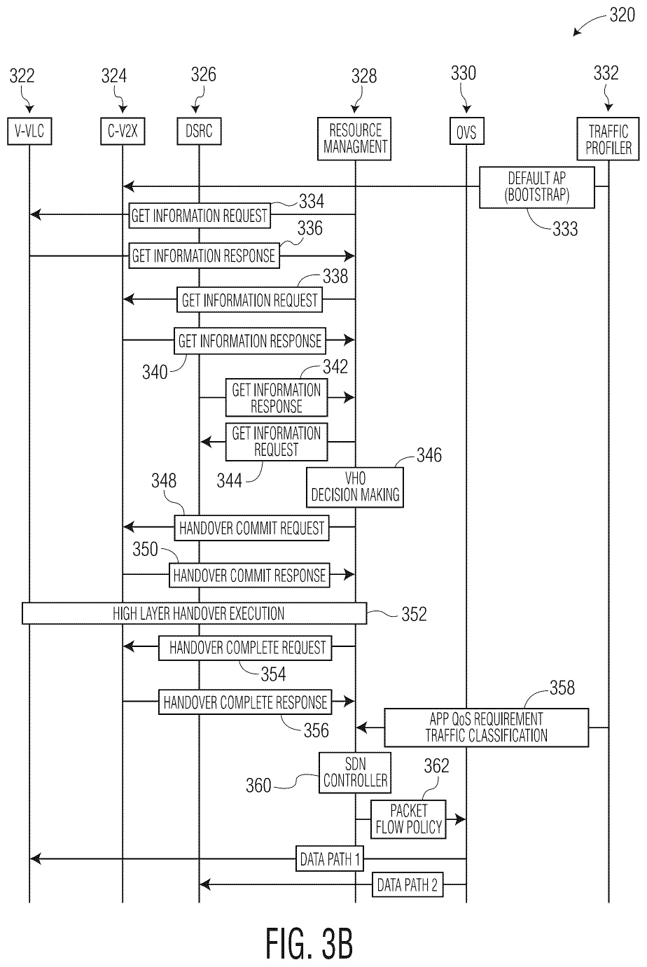

Referring to FIG. 3A, a flowchart 300 outlines a process for VHO in a vehicle communication system. The process generally includes step 302 for signaling other vehicles, step 304 for determining if data collection is complete, step 306 for providing data to the decision making algorithm, and step 308 for facilitating handover.

The process begins at initial signaling step 302. In this step, other vehicles and/or roadside units may be signaled via MIIS to collect networking information. This signaling process may be implemented by the system controller 122A, which controls the communication transceiver to gather network information from different networks. The gathered information may include data related to the vehicle's operation and environment, such as vehicle speed, location, and direction, as well as network data such as signal strength, network congestion, and network latency.

The flow then moves to the data collection complete decision point 304, which determines whether the signaling to collect data is complete. If the data collection is not complete, the process may loop back to continue data collection. This iterative process can ensure that comprehensive and up-to-date network information is gathered for the VHO decision-making process. In some cases, the data collection process may continue until a predetermined amount of data has been collected, or until a predetermined period of time has elapsed.

Once data collection is complete, the process advances to the data providing step 306, where the collected data is provided to the decision-making algorithm. The data providing step may involve the system controller 122A providing the gathered network information to the VHO decision-making algorithm. The VHO decision-making algorithm may use this information to determine one or more of the different networks through which to transmit messages. In some cases, the VHO decision-making algorithm may include executing a reinforcement learning algorithm that adjusts VHO policy based on message reception success rate and message transmission cost.

In handover facilitation step 308, other vehicles and/or roadside units are signaled via MICS to interact with different network interfaces and MIES to facilitate the handover protocol based on the output of the decision-making algorithm. The handover facilitation step may involve the system controller 122A implementing a second VHO signaling process to control the communication transceiver to execute the VHO to the determined one or more of the different networks. This may involve the system controller 122A controlling the communication transceiver to transmit messages over a single one of the different networks, duplicate messages over one or more of the different networks, or simultaneously transmit messages over two or more of the different networks.

In some variations, the processor may be configured to prioritize active applications related to navigation and safety over non-safety-critical applications during the VHO. This prioritization may be based on the quality-of-service (QoS) requirements of the different applications, the current network conditions, and the specific use case scenarios for the vehicle. By prioritizing safety-critical applications, the vehicle communication system may ensure that these applications receive the network resources they require to operate effectively, even in scenarios where network resources are limited.

Turning to FIG. 3B, a signaling diagram 320 of the signaling process of VHO decision-making and execution in a vehicle communication system is depicted. The process begins with the different communication technologies available for the vehicle, namely vehicular-VLC (V-VLC) technology 322, C-V2X technology 324, and DSRC technology 326. Resource Management 328 oversees the allocation of these communication resources, while Open vSwitch (OVS) 330 and Traffic Profiler 332 are involved in managing the network traffic.

The process initiates with a default AP bootstrap 333, which sets up the initial communication links for the vehicle. Following this, a Get Information Request 334 is sent to gather network data. This request may be sent to other vehicles, roadside units, or network servers, and may request information such as signal strength, network congestion, and network latency. A Get Information Response 336 is then received, providing the requested network information.

Subsequent information requests and responses, such as subsequent Get Information Request 338, subsequent Get Information Response 340, additional Get Information Response 342, and additional Get Information Request 344, are exchanged to continuously update the network information. These subsequent requests and responses may be used to gather additional network information, update previously gathered information, or gather information from different sources or over different networks.

VHO Decision Making process 346 can analyze the collected data to make handover decisions. In some embodiments, this decision-making process may involve executing a VHO decision-making algorithm, which may include executing a reinforcement learning algorithm that adjusts VHO policy based on message reception success rate and message transmission cost. In some cases, the VHO decision-making algorithm may prioritize active applications related to navigation and safety over non-safety-critical applications during the VHO. In other cases, the VHO decision-making algorithm may postpone the VHO in response to detection of a safety-critical event until the event is no longer present.

Once a decision is made, a Handover Commit Request 348 can be sent, and upon approval, a Handover Commit Response 350 can be received. Higher Layer Handover Execution process 352 then can implement the handover decision. This may involve the system controller 122A implementing a second VHO signaling process to control the communication transceiver to execute the VHO to the determined one or more of the different networks.

The process can conclude with a Handover Complete Request 354 and a Handover Complete Response 356, signaling the successful completion of the handover. App QoS Requirement Traffic Classification step 358 categorizes the traffic based on application QoS requirements, which is managed by the SDN Controller 360. Packet Flow Policy step 362 dictates the routing of data through the network, ensuring that the data follows the appropriate path, such as Data Path 1 or Data Path 2, as determined by the VHO process.

In other words, the VHO signaling begins with the available communication technologies for the vehicle. The process initiates with a default AP bootstrap, followed by a series of information requests and responses to gather and update network information. The process analyzes the collected data to make handover decisions which are executed via handover requests/responses.

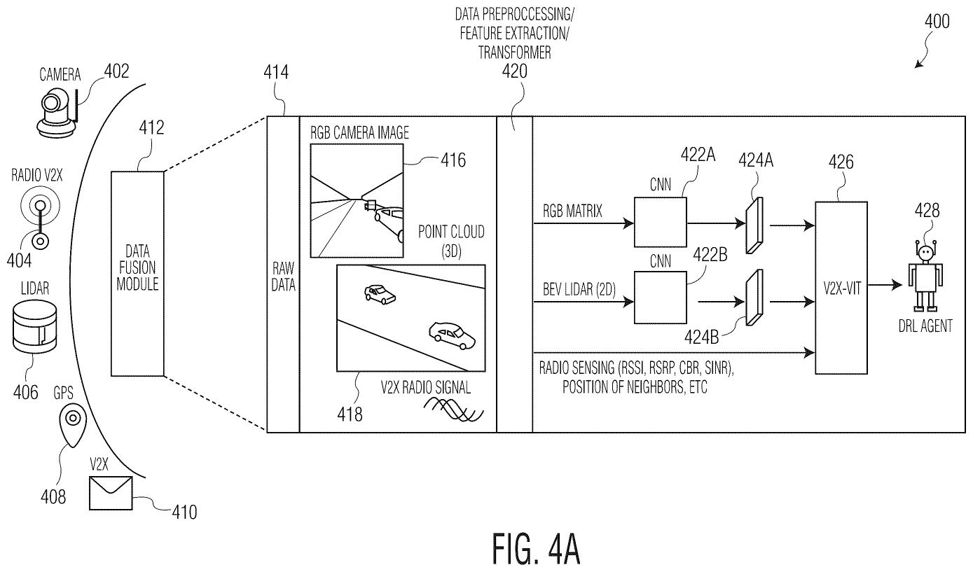

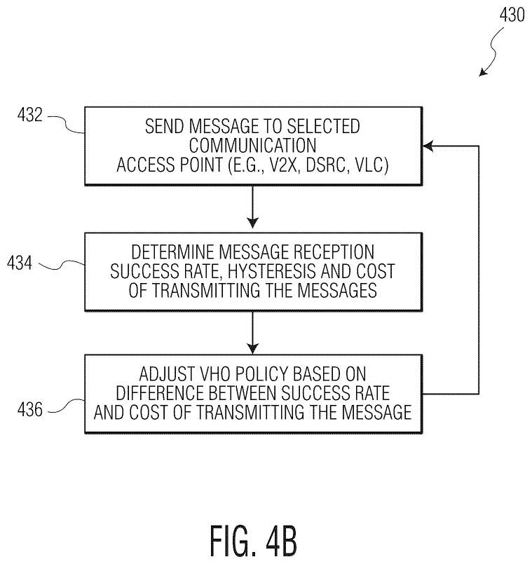

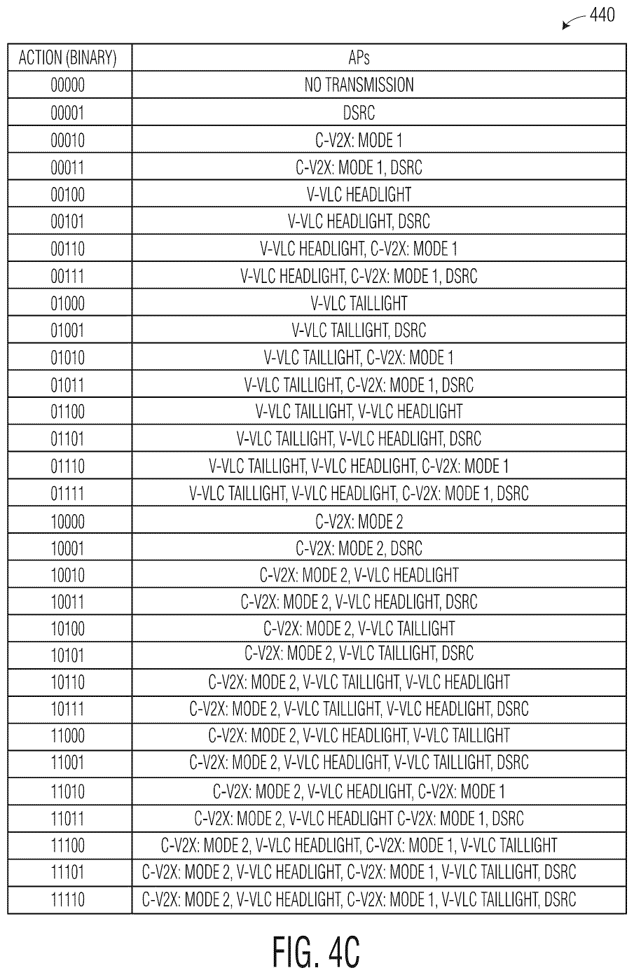

The VHO process is based on data collected from a variety of data sources including but not limited to, images captured by cameras, global positioning system (GPS) data, V2X data, etc. The collected data can be fused to create a comprehensive view of the vehicle's operation and surrounding environment, as well as the state of the different networks. This fused information can be utilized by a DRL agent, which forms the core of the VHO decision-making algorithm. The DRL agent can use reinforcement learning to adjust the VHO policy based on factors such as message reception success rate and message transmission cost. This approach allows the system to adapt to real-time changes in network, road, traffic, and weather conditions, thereby ensuring efficient and seamless handovers. An example of this data collection and fusion process is shown in FIG. 4A.

Specifically, in FIG. 4A, a block diagram of a vehicle communication system 400 is depicted. System 400 includes various data sources including camera 402, radio V2X receiver 404, lidar sensor 406, GPS device 408, and V2X communication receiver 410, all of which are coupled to a data fusion module 412. In some embodiments, the data fusion module 412 processes the data from one or more of these sources and produces raw data 414 which may include RGB camera image 416 and a point cloud image 418 of the vehicle environment. The images can be produced based on the fusion of images captured by the camera and other data from the other sensors to generate a comprehensive view of the vehicle's surroundings in the form of raw data 414, including RGB camera images 416 and point cloud images 418. Specifically, the RGB camera image 416 and the point cloud image 418 can depict the vehicle's surrounding environment, capturing visual data and three-dimensional spatial data respectively, which are relevant for the vehicle's operation, navigation, and decision-making processes in the context of vehicular communication and autonomous driving. This raw data 414 (e.g., images) is then processed by a feature extraction block 420 for extracting features.

The RGB camera image 416 and the point cloud image 418 can be processed by an RGB Matrix block 422A and a BEV Lidar block 422B, respectively, using Convolutional Neural Networks (CNNs). The output of the CNNs are fed into features block 424A and features block 424B, respectively, which output features to a V2X-Vision Transformer (V2X-VIT) block 426. The V2X-IT block 426 then provides these features to a DRL Agent block 428, which is responsible for decision-making in the vehicle communication system 400.

In one example, the CNNs may be designed to automatically and adaptively learn spatial hierarchies of features from the raw data. In the case of the RGB camera image 416, the CNN may identify and extract features such as edges, corners, and color blobs of objects in the images, which are beneficial to understanding the visual data. Similarly, for the point cloud image 418, the CNN may extract features that represent the three-dimensional spatial data, such as object shapes, sizes, and relative positions. These extracted features are then output to the feature blocks 424A and 424B which further process the extracted features to generate a more refined and meaningful representation of the data. This may involve operations such as normalization, dimensionality reduction, and feature selection, which aim to enhance the discriminative and informative aspects of the features while reducing noise and redundancy. The output of the feature blocks is a set of high-level features that capture the salient characteristics of the vehicle's surrounding environment. These high-level features are then provided to the V2X-IT block 426, which integrates them into the decision-making process of the DRL Agent block 428 which is executed by the communication software stack. Thus, the CNNs and feature blocks contribute to the system's ability to understand and adapt to its environment, thereby enhancing the efficiency and reliability of the vertical handover process.

In some aspects, the vehicle communication system 400 may include a sensor configured to collect data with respect to one or more of vehicle state, vehicle location, roadway conditions, traffic conditions, and weather conditions. The processor may be further configured to fuse the data collected by the sensor with the gathered network information when executing the VHO decision-making algorithm. This fusion of data may enhance the accuracy of network selection during the VHO process.

In other aspects, the processor may be further configured to fuse camera images and point cloud images of the roadway into the VHO decision-making algorithm to enhance accuracy of network selection. This fusion of visual data with network information may provide a comprehensive view of the vehicle's environment, which may in turn improve the accuracy of the VHO decision-making algorithm.

In some cases, the VHO decision-making algorithm may also be adjusted based on a predictive model that anticipates future network conditions using historical network and sensor data and current trends. This predictive model may allow the VHO decision-making algorithm to adapt to changing network conditions and make more accurate handover decisions.

The VHO decision-making algorithm, as described in the disclosed vehicle communication system, leverages the power of machine learning, specifically reinforcement learning, to adapt to the dynamic and unpredictable nature of the vehicular network. Reinforcement learning is a branch of machine learning that learns from the environment by interacting with it and receiving rewards or penalties based on the outcomes of its actions. This learning paradigm is particularly suited for the VHO decision-making algorithm due to its ability to learn and adapt from the dynamic vehicular network environment.

In the context of the VHO decision-making algorithm, the reinforcement learning agent learns to make decisions by receiving rewards and penalties based on the outcomes of its actions. The reward can be computed based on the number of messages successfully received, which serves as a measure of the reliability of the communication network. A higher number of successfully received messages indicates a more reliable network, thus leading to a higher reward for the reinforcement learning agent.

On the other hand, the penalty can be computed based on the cost of using different communication technologies, namely DSRC, C-V2X, and VLC, as well as the cost of hysteresis. The cost of using different communication technologies refers to the resources, such as bandwidth and power, consumed by the vehicle to communicate over these networks. The cost of hysteresis refers to the delay and disruption caused by switching from one network to another. A higher cost of using different communication technologies or a higher cost of hysteresis leads to a higher penalty for the reinforcement learning agent.

By balancing the rewards and penalties, the reinforcement learning agent learns to make decisions that maximize the reliability of the communication network while minimizing the cost of communication. This results in a VHO decision-making algorithm that can adapt to real-time changes in network conditions, road conditions, traffic conditions, and weather conditions, thereby ensuring efficient and seamless handovers in the vehicular network.

An example machine learning algorithm for decision making is described in equations (1)-(3) below where the solution includes multiple access points and imposes penalties against the hysteresis effect.

$$R = Reward - Penalty \qquad ( Equation 1 )$$

$$Reward = α * [ {E}_{message suscessfuly received} ] where α is the reward coefficient \qquad ( Equation 2 )$$

$$Penalty = {Cost}_{D S R C} * [ {E}_{Interface} ] + {Cost}_{C - V 2 X} * [ {E}_{Interface} ] + {Cost}_{V L C} * [ {E}_{Interface} ] + {Cost}_{h y s t e r i s i s} * [ {E}_{s w i t c h} ] \qquad ( Equation 3 )$$

$${E}_{Interface} : Boolean events that represent respectively the active interface$$

$${E}_{message suscessfuly received} : Boolean event equal to 1 if the message was successfully received$$

$${E}_{s w i t c h} : Boolean event equal to 1 if the decision making changes .$$

The VHO decision-making algorithm considers both the cost of communication and the reliability of communication in its decision-making process. The cost of communication is associated with the use of different communication technologies, with each technology having a different associated cost. The reliability of communication, on the other hand, is expressed as the packet delivery ratio, which is the proportion of messages successfully received to the total number of messages sent. A higher packet delivery ratio indicates a more reliable communication network.

Another factor considered by the VHO decision-making algorithm is the stability of the policy. To avoid frequent switching between different communication technologies, which can degrade the QoS and increase communication costs, the algorithm applies a penalty to discourage such “ping-pong” effects. This penalty is factored into the reinforcement learning process, guiding the algorithm to favor more stable policies that reduce execution of unnecessary handovers. This approach ensures a smooth and seamless VHO process, enhancing the efficiency and reliability of the vehicle communication system.

The VHO decision-making algorithm leverages machine learning to adapt to the dynamic vehicular network environment. By considering factors such as the cost of communication, the reliability of communication, and the stability of the policy, the algorithm can make informed decisions on when and how to perform VHO. This results in a vehicle communication system that can efficiently and reliably manage communication loads across different networks, ensuring seamless communication for vehicles in various scenarios.

The process 430 for adjusting VHO policy in a vehicle communication system is illustrated in FIG. 4B. The process generally includes step 432 for transmitting messages to selected APs, step 434 for determining message success and cost, step 436 for adjusting VHO policy based on success and cost.

The process commences with the message transmission step 432. In this initial phase, messages are dispatched to a chosen communication access point. The selection of the access point could be any of the available communication technologies such as V2X, DSRC, or VLC to name a few. Of course, other communication technologies for the access points are possible. This step may involve the transmission of messages over one or more networks. The transmission could occur over a single network, multiple networks in a redundant mode, or multiple networks in a load balancing mode. In the single network mode, all messages are transmitted over one network. In the redundant mode, duplicate messages are transmitted over multiple networks to ensure higher reliability. In the load balancing mode, the communication load is distributed across multiple networks to optimize network performance and ensure efficient use of network resources.

Following the message transmission, the system proceeds to the message success rate and cost determination step 434. In this phase, the system calculates the success rate of message reception and the cost of transmitting the messages. The success rate is quantified as the ratio of messages successfully received to the total number of messages sent. This metric provides an indication of the reliability of the communication network. On the other hand, the cost is associated with the use of different communication technologies and the cost of hysteresis. The cost of hysteresis refers to the cost incurred due to the delay in switching from one network to another. This cost is a useful part of the decision-making process for VHO as it can impact the efficiency of the communication system.

In VHO policy adjustment step 436, the VHO policy is adjusted based on the difference between the success rate and the cost of transmitting the message. This adjustment is performed by a reinforcement learning algorithm, which adapts the VHO policy to optimize the balance between communication reliability and cost. The reinforcement learning algorithm learns from the environment by interacting with it and receiving rewards or penalties. In this context, the reward is computed based on the number of messages successfully received, while the penalty is computed based on the cost of using different communication technologies and the cost of hysteresis. This dynamic and adaptive approach to network selection and load balancing ensures that the vehicle is communicating efficiently over the available networks for a given scenario.

Referring to FIG. 4C, a table 440 is depicted that outlines the relationship between binary action codes and the corresponding AP selection for a vehicle communication mode. The left column of the table lists binary codes under the header “Action (Binary),” while the right column lists the combinations of access points under the header “APs.” Each binary code corresponds to a specific combination of access points, which include but are not limited to “No Transmission,” “DSRC,” “C-V2X: Mode 1,” “C-V2X: Mode 2,” “V-VLC Headlight,” and “V-VLC Taillight.” The table 440 provides a comprehensive mapping of binary action codes to the various modes of communication available in the vehicle communication system, indicating the possible configurations for transmitting messages.

In some aspects, the binary action codes may be used by the system controller 122A to control the communication transceiver to transmit messages over the determined access points. The specific access points and the amount of data sent via each access point may be determined by the binary action code, which may be adjusted based on a predictive model that anticipates future network conditions using historical network and sensor data and current trends. In other aspects, the binary action codes may be used to facilitate the execution of the VHO. For example, a binary action code corresponding to “No Transmission” may be used to indicate that no messages are to be transmitted over any of the networks, while a binary action code corresponding to “DSRC” may be used to indicate that messages are to be transmitted over the DSRC network. Similarly, binary action codes corresponding to “C-V2X: Mode 1,” “C-V2X: Mode 2,” “V-VLC Headlight,” and “V-VLC Taillight” may be used to indicate that messages are to be transmitted over the corresponding networks.

In some cases, the binary action codes may be used to facilitate load balancing when transmitting the messages over two or more of the different networks. For example, a binary action code corresponding to a combination of “DSRC” and “V-VLC Headlight” may be used to indicate that messages are to be simultaneously transmitted over the DSRC and V-VLC Headlight networks. The specific distribution of the communication load across the different networks may be determined by the binary action code, which may be adjusted based on a predictive model that anticipates future network conditions using historical network and sensor data and current trends.

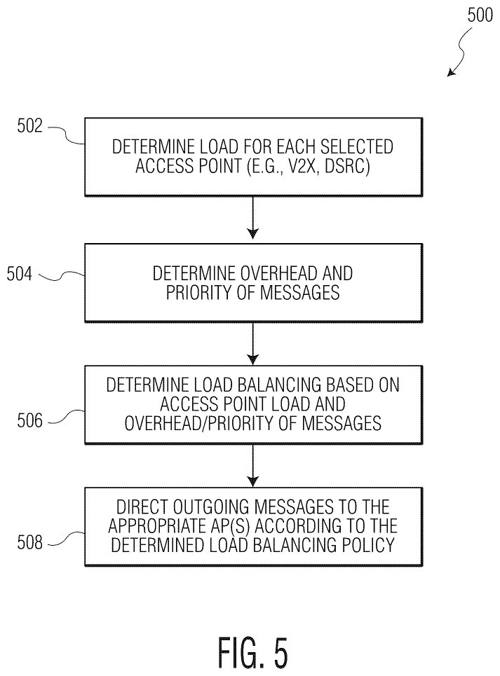

Referring to FIG. 5, a flowchart 500 outlines a process for managing communication loads in a vehicle communication system. The process generally includes step 502 for determining load on the APs, step 504 for determining overhead and priority, step 506 for determining load balancing, and step 508 for directing messages to the APs based on load balancing.

The process begins with the access point load determination 502, where the load for each selected access point, such as V2X and DSRC, is determined. This determination may involve assessing the current network traffic, the capacity of the access points, and the communication requirements of the vehicle. In some cases, the load determination may also consider the load of one or more servers handling the messages, the payload of the messages, and the priority of the messages.

Following the load determination, the process proceeds to the message overhead and priority determination 504. In some embodiments, the step involves assessing the overhead and priority of the messages to be transmitted. The overhead may refer to the additional data or processing requirements associated with transmitting the messages, while the priority may refer to the relative urgency or precedence of the messages. For example, messages related to safety-critical applications may be assigned a higher priority than messages related to non-safety-critical applications.

Subsequently, the process advances to the load balancing determination 506. This step involves deciding whether to perform load balancing based on the determined load of the access points and the determined overhead and priority of the messages. Load balancing may involve distributing the communication load across multiple access points to optimize network performance and ensure efficient use of network resources. In some cases, load balancing may be performed when transmitting the messages over two or more of the different networks, considering one or more of a load of one or more servers handling the messages, a payload of the messages, and priority of the messages when determining routing of the messages through the different networks.

Finally, the process concludes with the outgoing message direction 508, where outgoing messages are directed to the appropriate access points according to the determined load balancing policy. This step may involve the system controller 122A controlling the communication transceiver to transmit the messages over the determined access points. The specific access points and the amount of data sent via each access point may be determined by the load balancing policy, which may be adjusted based on a predictive model that anticipates future network conditions using historical network and sensor data and current trends.

In the disclosed vehicle communication system, load balancing is performed by the decision-making module, which determines the reliability of the available APs. The decision-making module, which utilizes a machine learning algorithm, specifically reinforcement learning, evaluates the network conditions, traffic conditions, and data requirements of the vehicle to make informed decisions about the APs to use for communication.

If the decision-making module determines that one AP is reliable, the system enters a single communication mode. In this mode, all messages are transmitted over a single network, ensuring efficient and reliable communication. However, if the decision-making module determines that two or more APs are reliable, the system has the flexibility to enter either a load balancing mode or a redundant mode. In the load balancing mode, the communication load is distributed across multiple APs, optimizing network performance and ensuring efficient use of network resources. In the redundant mode, duplicate messages are transmitted over one or more networks to achieve higher reliability and throughput. The choice between load balancing mode and redundant mode is made based on the priority of the packets. If the priority of the packets is above a predetermined priority threshold, the system opts for the redundant mode over the load balancing mode, ensuring that high-priority messages are reliably delivered.

The disclosed vehicle communication system employs an algorithm for selecting APs by computing a utility function based on several parameters, including AP throughput, throughput tolerances, and a throughput threshold. The AP throughput refers to the rate at which data packets are successfully transmitted over the network via a particular AP. The throughput tolerances represent the acceptable variations in the AP throughput, accounting for fluctuations in network conditions. The throughput threshold is a predefined value that the AP throughput is expected to meet or exceed for the AP to be considered reliable. The algorithm evaluates each AP based on these parameters and selects the AP or combination of APs that maximize the utility function. This ensures that the vehicle communication system utilizes the APs that offer the optimum balance of high throughput and low latency, thereby enhancing the efficiency and reliability of the communication system.

An example algorithm for selecting an AP based on various criteria is shown in equations (4)-(10) below.

$$Throughput for APs : {V}_{k} : {V}_{1} ( delay ) , {V}_{2} ( throughput ) , {V}_{3} ( beaconing rate ) , etc . \qquad ( Equation 4 )$$

$$For each application criteria the profiler provides tolernace {V}_{min} , {V}_{max} and a threshold {V}_{threshold} that devides the interval into two zones .$$

$$The utility function for each criteria :$$

$${U}_{L} ( {V}_{k} ) = 0 \% under the limit : {V}_{k} < {V}_{min} \qquad ( Equation 5 )$$

$${U}_{L} ( {V}_{k} ) = {( 1 - \frac{1}{1 + ( \frac{{V}_{k} - {V}_{min}}{{V}_{threshold} {V}_{min}} ) α} )}^{{W}_{k}} unsatisfied : {V}_{min} \leq {V}_{k} \leq {V}_{threshold} \qquad ( Equation 6 )$$

$${U}_{L} ( {V}_{k} ) = {( \frac{1}{1 + ( \frac{{V}_{k} - {V}_{max}}{{V}_{threshold} - {V}_{max}} ) α} )}^{{W}_{k}} satisfied : {V}_{threshold} < {V}_{k} \leq {V}_{max} \qquad ( Equation 7 )$$

$${U}_{L} ( {V}_{k} ) = 100 \% : {V}_{k} > {V}_{max} \qquad ( Equation 8 )$$

$$α and {W}_{k} : are respectively the steepness of the sigmoid function and the weight and the weight of the k criteria$$

$$The utility function for overall satisfaction for link L :$$

$${U}_{L} = {π}_{k} {U}_{L} ( {V}_{k} ) \qquad ( Equation 9 )$$

$$If {U}_{L 1} > {U}_{L 2} Transmit packet through communication link L 1 ; where {U}_{L 1} is the utility function for communication link 1 via API 1 and {U}_{L 2} is the utility function for communication link 2 via API 2 \qquad ( Equation 10 )$$

In summary, the vehicle communication system 100, as described in the various aspects and examples, provides a novel approach to managing communication in vehicular networks. The system 100 leverages a combination of different communication technologies to ensure efficient and reliable communication under various network conditions, traffic conditions, and vehicle operation scenarios. The system 100 employs a VHO process that dynamically switches between different networks based on a decision-making algorithm. This algorithm, which may incorporate reinforcement learning techniques, adjusts the VHO policy based on factors such as message reception success rate and message transmission cost. This dynamic and adaptive approach to network selection and load balancing ensures that the vehicle is communicating efficiently over the available networks for a given scenario.

The vehicle communication system 100 offers several potential benefits. For instance, by dynamically switching between different networks and balancing the communication load across multiple access points, the system 100 can optimize network performance and ensure efficient use of network resources. This can lead to improved communication reliability, reduced latency, and increased throughput, which are particularly beneficial for safety-critical applications such as autonomous driving and emergency response. Furthermore, by incorporating machine learning techniques into the decision-making process, the system 100 can adapt to changing network conditions and make more accurate handover decisions, thereby enhancing the overall performance and robustness of the communication system.

The vehicle communication system 100 has potential applications in a wide range of scenarios. For instance, it can be used in connected and autonomous vehicles to facilitate V2V and V2I communication, enabling advanced driving features such as cooperative adaptive cruise control, intersection collision warning, and emergency vehicle warning. The system 100 can also be used in intelligent transportation systems to manage communication between vehicles and roadside units, supporting applications such as traffic signal priority, speed limit enforcement, and traffic congestion detection. Furthermore, the system 100 can be used in vehicular ad hoc networks to enable direct communication between vehicles, supporting applications such as platooning, cooperative merging, and cooperative collision avoidance. In all these applications, the vehicle communication system 100 can provide a flexible and efficient solution for managing communication in vehicular networks.

In a benchmarking example, four DRL algorithms may be evaluated for performance. These algorithms included proximal policy optimization (PPO), trust region policy optimization (TRPO), soft-actor-critic (SAC), and Rainbow deep Q-Network (DQN). PPO, TRPO, and SAC are actor-critic methods. Specifically, PPO introduces a clipped objective function to prevent drastic policy changes that takes the form in equation (11):

$$L ( θ ) = 𝔼 [ min ( \frac{{π}_{θ} ( a \vert s )}{{π}_{{θ}_{old}} ( a \vert s )} A ( s , a ) , \qquad ( Equation 11 )$$

$$clip ( \frac{{π}_{θ} ( a \vert s )}{{π}_{{θ}_{old}} ( a \vert s )} , 1 - ∈ , 1 + ∈ ) A ( s , a ) ) ]$$

TRPO employs a trust region to constrain policy updates ensuring the new policy does not significantly diverge, it optimizes a surrogate of

$$J ( θ ) = 𝔼 [ {\sum }_{t = 0}^{T} {γ}^{t} r ( {s}_{t} , {a}_{t} ) ]$$

maintaining a trust region constraint as shown in equation (12):

$$L ( θ ) = 𝔼 [ \frac{{π}_{θ} ( a \vert S )}{{π}_{{θ}_{old}} ( a \vert S )} A ( s , a ) ] \qquad ( Equation 12 )$$

and SAC is an off-policy method that balances policy optimization and value-based methods with an entropy term as shown in equation (13):

$$\tilde{J} ( θ ) = 𝔼 [ {\sum }_{t = 0}^{T} {γ}^{t} ( r ( {s}_{t} , {a}_{t} ) + a ℋ ( π ( \cdot \vert {s}_{t} ) ) ) ] \qquad ( Equation 13 )$$

On the other hand, Rainbow DQN is a value-based distributional method, combining various techniques like double Q-learning, prioritized experience replay based on temporal difference (TD) error, dueling network, multi-step and distributional learning. These algorithms may be applied to the serpentine simulation environment described below. The results offer insights into the effectiveness and appropriateness of each method for the vehicular communication problem.

In this example, the performance simulation utilizes two scenarios that involve two vehicles (a follower and a leader) following each other on a very curvy road and communicating via V2X technologies (VLC taillight, VLC headlight, and DSRC). The nature of these environments, generated via SUMO traffic simulation software present a challenging situation. Table I summarizes example simulation parameters used in these scenarios.

TABLE I
Simulation parameters.

| Parameter | Value | |
|---|---|---|
| Packet Byte length | 1024 | byte |
| Beaconing Frequency | 10 | Hz |
| Transmission power (DSRC) | 20 | mW |
| Bitrate (DSRC)/(VLC) | 6 Mbps/1 Mbps | |
| Vehicles speed | 30-40 | km/h |
| Simulation time | 400 | s |

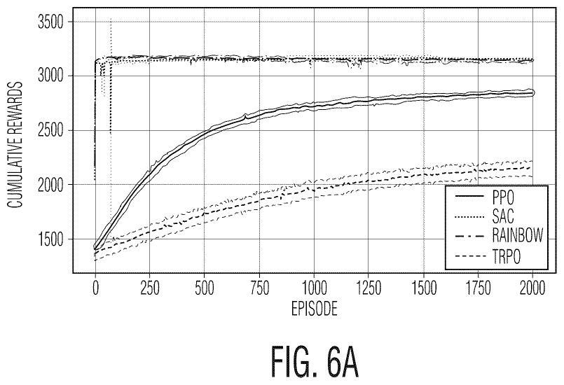

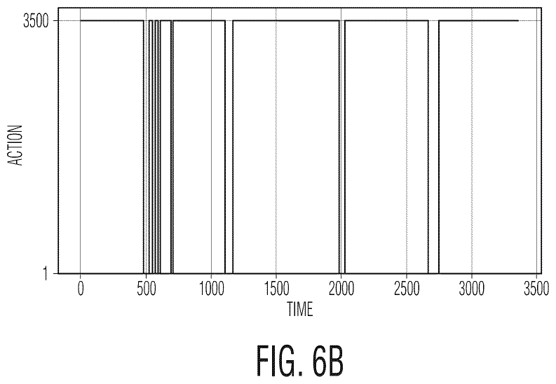

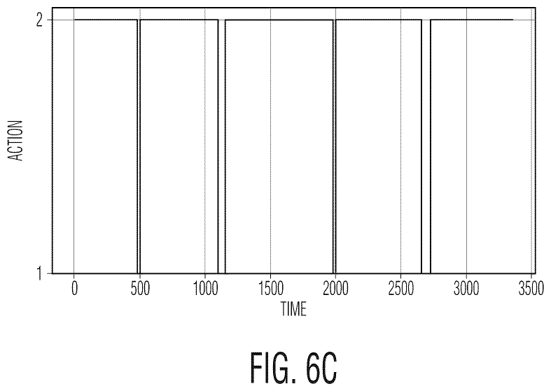

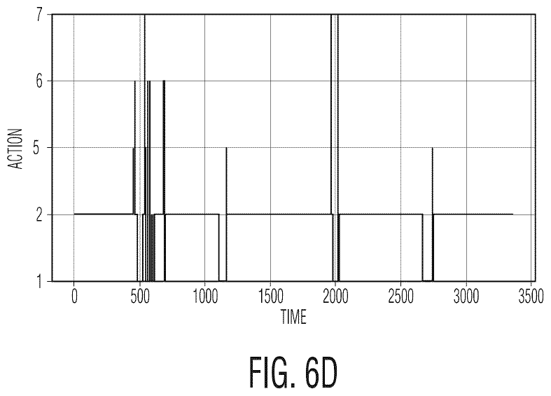

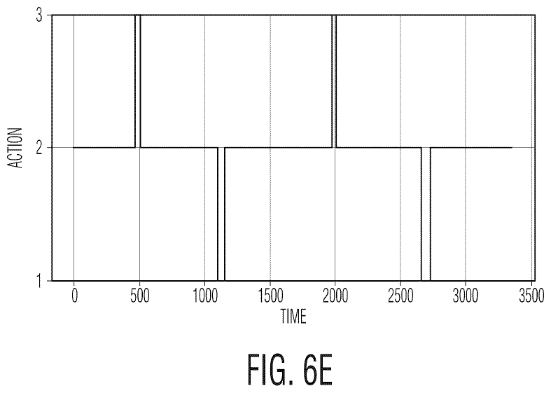

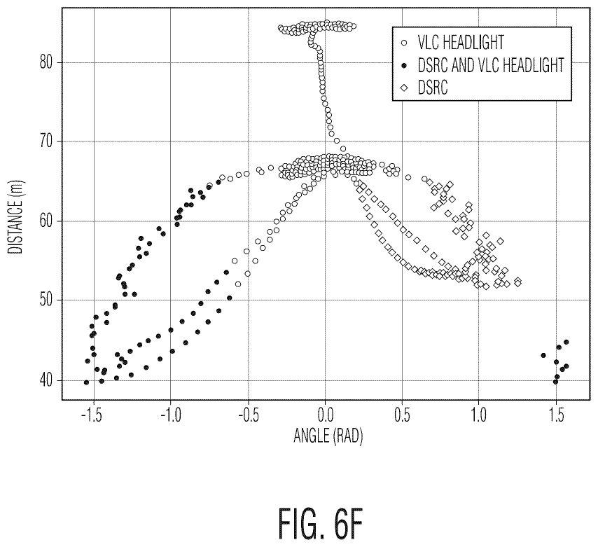

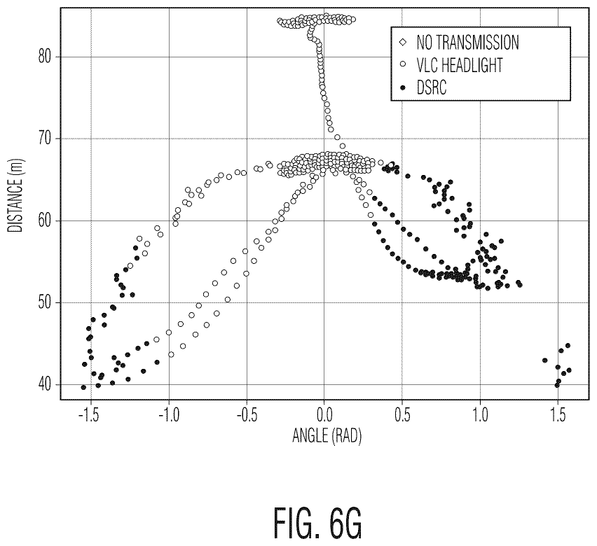

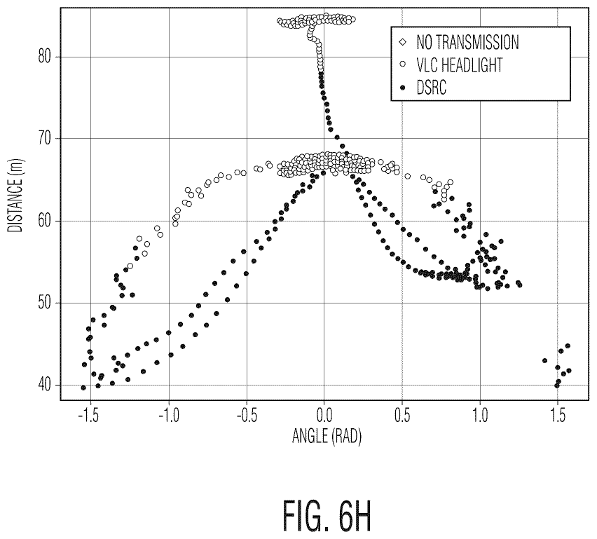

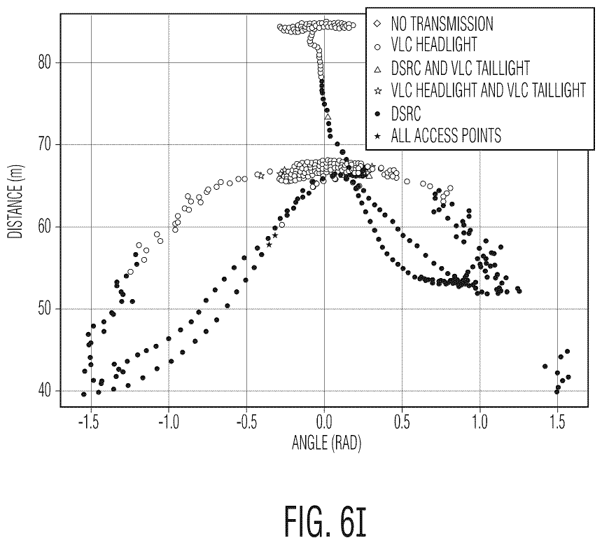

The follower is the one who owns the DRL agent. For each message transmitted to the leader, it has to select the optimal communication link based on the observation. The first scenario may be used to train and test the different algorithms. This first scenario is a serpentine with few hairpin curves, while the second scenario with many hairpin curves was dedicated to robustness testing. Four DRL agents (PPO, TRPO, Rainbow DQN, SAC) were using scenario 1 and fine-tuned with a grid search on the main hyperparameters (see Table II). FIG. 6A displays an example of the learning curve for each model trained in the simulation environment.

TABLE II
Deep RL Benchmark Grid search.

| Algorithm | Hyper-parameter | Values |
|---|---|---|
| RainbowDQN | [symbol] (learning rate) | {0.1, 0.3} |
| | β (Weight Decay) | {0.5, 0.7} |
| | [symbol] size | {25, 100} |
| | Prior epsilon | {1e [symbol] , 1e [symbol] } |
| TRPO | δ (TR Upper Bound) | {0.005, 0.01} |
| | Depth of neural nets | {32, 64} |
| | line search max [symbol] | {10, 20} |
| SAC | [symbol] (soft update coefficient) | {0.005, 1e⁻²} |
| | Learning rate | {3e [symbol] , 5e [symbol] } |
| | Batch size | {64, 128, 256} |
| PPO | Learning rate [symbol] | {1e⁻⁵, 1e⁻²} |
| | Learning rate Critic | {1e [symbol] , 1e⁻²} |
| | [symbol] (Epsilon clip) | {0.2, 0.3} |

[symbol]

indicates data missing or illegible when filed

In this example, the agents learned the following: maximize transmission reliability (expressed as Packet Delivery Ratio (PDR)), use no taillight (no vehicle behind), and minimize redundancy. Based on these observations, four metrics were established to assess and quantify performance. These metrics included reliability, VLC usage rate, no redundancy, and taillight rate. Five policies were adopted including DSRC/VLC only, hand-crafted heuristic formula and data-driven policies based on Convex-Hull formula and a deep RL Multi-Q-Regressor algorithm. Table IV summarizes these results. In FIGS. 6B, 6C, 6D and 6E, examples of the output action are displayed as a function of the simulation time. Moreover, Table III shows the percentage of each output action.

TABLE III
Learned strategies (PPO, SAC, Rainbow DQN, TRPO best model).

| V2X technologies | PPO | Rainbow DQN | TRPO | SAC |
|---|---|---|---|---|
| No transmission | 0 | 0 | 0.02 | 0.02 |
| DSRC | 7% | 8.27% | [symbol] | 8.29% |
| VLC Headlight | 91% | [symbol] | [symbol] | 91.67% |
| DSRC & Headligth | [symbol] | 0% | 0% | 0% |
| VLC Tailligth | 0% | 0% | 0% | 0% |
| DSRC & Tailligth | 0% | 0.44% | 0% | 0% |
| Tailligth & Headligth | 0% | [symbol] | 0% | 0% |
| All available | 0% | 0.11% | 0% | 0% |
| technologies | | | | |

[symbol]

indicates data missing or illegible when filed

It may be concluded from this simulation example that the optimal action for the agents is VLC Headlight. Furthermore, the PPO is shown to have the most stable learned policy, followed by the TRPO, SAC and Rainbow DQN. The policy stability is explained through the entropy and policy constraints used in the learning process. The difference in policy stability between the PPO, TRPO, SAC, and Rainbow DQN when applied to vehicular communication can be related to their intrinsic characteristics in terms of entropy and policy constraints. PPO and TRPO are methods with constrained policies, where the update step is limited to a trust region to ensure policy stability and prevent detrimental changes. This results in more consistent decisions regarding the choice of communication technology, thus leading to fewer switches. On the other hand, SAC employs an entropy regularization term, which encourages exploration of the action space. In the context of the above-described vehicular communication scenario, this translates into more frequent shifts between communication technologies as the algorithm is encouraged to explore and exploit different options to find the optimal balance between reward and cost. Rainbow-DQN, while not directly utilizing entropy for exploration, combines several enhancements over standard DQN that may cause it to behave more variably in this context. The increased exploration encouraged by SAC and Rainbow-DQN may lead to higher reward in some settings, but in this case, it seems to cause more fluctuation in the choice of communication technology compared to PPO and TRPO. In Table IV, the number of switches for each agent is computed. This metric quantifies the stability described in the previous paragraph. Even if the SAC gives better performance, the PPO outperformed it in term of number of switches. In the design of vertical handover, it is beneficial to consider the sensitivity of the switching mechanism to not impact to much the End-To-End (E2E) delay.

TABLE IV
DRL performances on scenario 1. SoA
refers to the DRL algorithm in (9).

| Metrics | PPO | SoA | SAC | Rainbow | TRPO |
|---|---|---|---|---|---|
| Reliability | [symbol] | 99.5% | [symbol] | [symbol] | [symbol] |
| VLC utilization rate | [symbol] | [symbol] | [symbol] | [symbol] | 95.35% |
| No Redundancy | [symbol] | [symbol] | 100% | [symbol] | 100% |
| Taillight [symbol] | 0% | 0% | 0% | [symbol] | 0% |
| Number of switch | 8 | / | 27 | 29 | 15 |

[symbol]

indicates data missing or illegible when filed

FIGS. 6F, 6G, 6H, 6I plot examples of the actions as a function of the states (distance & angle). These figures can be used to illustrate the strategy chosen for each state. The simulation tool uses an empirical model. Since the data comes from a real headlight module, this radiation pattern includes the effect of high beam and low beam coming from real vehicular headlight modules. As observed, the agent chooses to use the VLC when the leader and follower are in Line Of Sight (LOS), since the conditions for its use are favorable and it's less costly (as defined in the reward design). Also, an asymmetric decision is observed to use VLC respectively to the zero angle caused by asymmetric light distribution. Manufacturers design the low beam for this effect with the purpose so as not to disturb the oncoming traffic while properly illuminating the road in front of the vehicle.

Example boundaries of each decision are shown. On these boundaries, there is some overlapping between actions. This creates a hysteresis effect although some points represent almost the same state, the agent takes different decision, and this is a main cause of the ping-pong effect, which makes the switch sensitive and leads to unnecessary transitions. In telecommunications, two parameters may be considered when designing VHO. These include hysteresis and Time To Trigger (TTT). In other words, a handover hysteresis margin that limits this effect is found such that this feature is taken into account in the reward design.

Table V describes the space complexity of the different algorithms that are used in the benchmark. These specific architectures may be selected by following the default structures from standard libraries such as CleanRL and Acme. The two methods with the largest number of parameters, namely SAC and Rainbow-DQN, yielded the best performance (see FIG. 6A).

TABLE V
Selected architecture for each DRL algorithm.

| Metrics | PPO | SAC | RainBow DQN | TRPO |
|---|---|---|---|---|
| Nbr. trainable | 9545 | 276512 | 62689 | 1225 |
| parameters | | | | |
| Actor network | 4, 64, 64, 8 | 4, 256, 256, 8 | / | 4, 64, 8 |
| structure | | | | |
| Critic network | 4, 64, 64, 1 | 4, 256, 256, 8 | / | 4, 64, 1 |
| structure | | | | |
| Value network | / | / | 4, 128, | / |
| structure | | | 128, 25 | |
| Advantage | / | / | 4, 128, | / |
| network | | | 128, 200 | |
| structure | | | | |

In deep reinforcement learning, ‘sample complexity’ refers to the minimal number of episodes necessary for an algorithm to converge. As illustrated in FIG. 6A, SAC and Rainbow showcase notably lower sample complexities, needing fewer than 100 episodes, in contrast to TRPO and PPO. This performance is largely attributed to the robust exploration strategies of SAC and Rainbow DQN. Specifically, while TRPO and PPO are designed around trust region methods and policy gradient improvements respectively, SAC incorporates entropy into the reward, promoting more explorative policies.

Similarly, Rainbow combines several advancements in DQN architecture, such as prioritized experience replay and dueling networks, enabling a richer understanding of the environment and more efficient learning trajectories. The implications are significant for V2X vehicular communication problems where rapid learning is crucial due to the dynamic nature of vehicular environments and the critical need for safety.

When dealing with real-world scenarios, one should consider that the environment varies across time due to its non-stationary behavior. Thus, in order to evaluate the robustness of the DRL algorithms tested above to the variation of the environment, it may be beneficial to analyze the generalization ability of the policies by picking up the two best learned policies of each algorithm and tested their performance in similar configuration with scenario 2. Table VI summarizes performance in terms of reliability obtained with the unseen scenario.

TABLE VI
Performances on scenario 2.

| Reliability | PPO | SAC | RainBow DQN | TRPO |
|---|---|---|---|---|
| 1^{st} best model | 84.84% | 94.78% | 71.84% | 78.81% |
| 2^{nd} best model | 97.57% | 97.71% | 95.62% | 95.27% |

As observed, for the 1^{st} best models of the benchmark, there is gap of performance between the training dataset and new data. However, the 2^{nd} best model approaches better performance on the training environment. This phenomenon is likely caused by overfitting, which happens when the model is overtrained on the training environment. Traditionally, for a machine learning model, overfitting is avoided by adding a regularization technique.

In some aspects, the disclosed vehicle communication system and its vertical handover (VHO) procedures may be applicable beyond vehicular networks, extending to multimedia and mobile Internet of Things (IoT) devices. These devices, which often require seamless network connectivity to function effectively, could benefit from the adaptive VHO decision-making algorithm that takes into account real-time network conditions, device mobility, and data transmission requirements. For instance, multimedia devices that stream high-bandwidth content could utilize the system's load balancing capabilities to maintain uninterrupted service, while mobile IoT devices, which may frequently move between network coverage areas, could leverage the system's predictive model to anticipate and adapt to changing network conditions, ensuring consistent connectivity and data exchange. This adaptability makes the disclosed system a versatile solution for a wide range of applications where reliable and efficient wireless communication is paramount.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A vehicle communication system for performing vertical handover (VHO), comprising:
a communication transceiver comprising a plurality of access points configured to receive and transmit wireless signals via different networks; and
a processor operatively connected to the communication transceiver, the processor configured to:
implement a first VHO signaling process to control the communication transceiver to gather network information from the different networks,
execute a VHO decision-making algorithm to determine, based on the gathered network information, one or more of the different networks through which to transmit messages via one or more of the plurality of access points, the VHO decision-making algorithm comprising executing a reinforcement learning algorithm that adjusts VHO policy based on message reception success rate and message transmission cost, and
implement a second VHO signaling process to control the communication transceiver to execute the VHO to the determined one or more of the different networks.

2. The vehicle communication system of claim 1, wherein the processor is configured to trigger the execution of the VHO in response to detected network events or detected vehicle events.

3. The vehicle communication system of claim 1, wherein the plurality of access points comprises dedicated short-range communication (DSRC), vehicle-to-X (V2X) communication and visible light communication (VLC).

4. The vehicle communication system of claim 1, wherein the processor is further configured to execute the VHO decision-making algorithm to determine execution of one of:
a single communication mode where the messages are transmitted over a single one of the different networks,
a redundant mode where duplicate messages are transmitted over one or more of the different networks, or
a load balancing mode where the messages are simultaneously transmitted over two or more of the different networks.

5. The vehicle communication system of claim 1, wherein the processor is further configured to perform load balancing when transmitting the messages over two or more of the different networks, the load balancing considering one or more of a load of one or more servers handling the messages, a payload of the messages and priority of the messages when determining routing of the messages through the different networks.

6. The vehicle communication system of claim 1, further comprising:
a sensor configured to collect data with respect to one or more of vehicle state, vehicle location, roadway conditions, traffic conditions and weather conditions, and
the processor is further configured to fuse the data collected by the sensor with the gathered network information when executing the VHO decision-making algorithm.

7. The vehicle communication system of claim 1, wherein the processor is configured to prioritize active applications related to navigation and safety over non-safety-critical applications during the VHO.

8. The vehicle communication system of claim 1, wherein the processor is configured to postpone the VHO in response to detection of a safety-critical event until the event is no longer present.

9. The vehicle communication system of claim 1, wherein the processor is further configured to adjust the VHO decision-making algorithm based on a predictive model that anticipates future network conditions using historical network and sensor data and current trends.

10. The vehicle communication system of claim 1, wherein the processor is further configured to fuse camera images and point cloud images of the roadway into the VHO decision-making algorithm to enhance accuracy of network selection.

11. A method for performing vertical handover (VHO) in a vehicle communication system, comprising:
implementing a first VHO signaling process to control a communication transceiver to gather network information from different networks;
executing a VHO decision-making algorithm with a processor to determine, based on the gathered network information, one or more of the different networks through which to transmit messages via one or more of a plurality of access points, wherein the VHO decision-making algorithm comprises executing a reinforcement learning algorithm that adjusts VHO policy based on message reception success rate and message transmission cost; and
implementing a second VHO signaling process to control the communication transceiver to execute the VHO to the determined one or more of the different networks.

12. The method of claim 11, further comprising:
triggering the execution of the VHO in response to detected network events or detected vehicle events.

13. The method of claim 12, wherein the plurality of access points comprise dedicated short range communication (DSRC), vehicle-to-X (V2X) communication, and visible light communication (VLC).

14. The method of claim 11, further comprising:
executing the VHO decision-making algorithm by selecting one of:
a single communication mode where messages are transmitted over a single one of the different networks,
a redundant mode where duplicate messages are transmitted over one or more of the different networks, or
a load balancing mode where messages are simultaneously transmitted over two or more of the different networks.

15. The method of claim 11, further comprising:
performing load balancing when transmitting the messages over two or more of the different networks, considering one or more of a load of one or more servers handling the messages, a payload of the messages, and priority of the messages when determining routing of the messages through the different networks.

16. The method of claim 11, further comprising:
collecting data with respect to one or more of vehicle state, vehicle location, roadway conditions, traffic conditions, and weather conditions using a sensor, and fusing the data collected by the sensor with the gathered network information when executing the VHO decision-making algorithm.

17. The method of claim 11, further comprising:
prioritizing active applications related to navigation and safety over non-safety-critical applications during the VHO.

18. The method of claim 11, further comprising:
postponing the VHO in response to detection of a safety-critical event until the event is no longer present.

19. The method of claim 11, further comprising:
adjusting the VHO decision-making algorithm based on a predictive model that anticipates future network conditions using historical network and sensor data and current trends.

20. The method of claim 11, further comprising:
fusing camera images and point cloud images of the roadway into the VHO decision-making algorithm to enhance accuracy of network selection.
